(19) United States
(12) Patent Application Publication
(10) Pub. No.: US 2008/0123936 A1
(43) Pub. Date: May 29, 2008

(54) Method of reviewing defects and an apparatus thereon

(75) Inventor: Tomohiro Funakoshi, Hitachinaka (JP)

Correspondence Address: MCDERMOTT WILL & EMERY LLP, 600 13TH STREET, N.W., WASHINGTON, DC, 20005-3096, US

(73) Assignee: HITACHI HIGH-TECHNOLOGIES CORPORATION

(21) Appl. No.: 11/984,721

(22) Filed: Nov. 21, 2007

(30) Foreign Application Priority Data
Nov. 24, 2006 (JP) 2006-316903

(51) Int. Cl. G06K 9/00

(52) U.S. Cl. 382/149

(57) ABSTRACT

The present invention solves the problem that a plenty of time required for data processing/alignment as the number of defects detected by an inspection apparatus increases. It is possible to provide a defect review method and an apparatus having the function to improve operability and user-friendliness, and rapidly search for a hint for identifying a defect cause. In order to achieve the object, the method and the apparatus have a configuration for displaying a defect map obtained by processing data outputted from an inspection apparatus and a review apparatus and repeatedly inspecting the data under the same inspection condition or while changing the inspection condition, together with a list of the corresponding images; and linking their defects so as to check/judge whether a desired defect is detected according to an enormous amount of image data.

### BACKGROUND OF THE INVENTION

### Field of the Invention

The present invention relates to a method and an apparatus of reviewing defects for supporting a condition decision and an apparatus performance check of a review apparatus which observes defects obtained by an external inspection apparatus which detects foreign matters, pattern defects, and the like on the surface of a semiconductor wafer, a photo mask, a magnetic disc, a liquid crystal substrate, and the like.

In a semiconductor manufacturing process, a foreign matter or a pattern defect on the wafer surface causes a defective product. Accordingly, it is necessary to constantly quantify foreign matters, pattern defects, and the like (hereinafter, referred to simply as defects) and monitor whether the production apparatus and the production environment have no problem. Furthermore, by reviewing a defect shape, it is necessary to check whether the defect gives a fatal affect to the product.

Conventionally, such a review work is performed visual inspection by a person. For this, there has been a problem that depending on the person who performs review, the defect position and the defect type of the object to be reviewed may be varied and the defect to be reviewed cannot be constant. Recently, in order to solve these problems, the image processing technique is used to automatically judge the defect size, the defect type, and the like, such as the automatic defect review (ADR) technique and the automatic defect classification (ADC) technique are used.

For example, JP-A-10-135288 discloses a system for effectively observing, i.e., reviewing a pattern formed on an inspected part such as a wafer by using a scanning electron microscope (SEM) type review apparatus while reducing a load on an operator of the apparatus.

These years, the semiconductor device processing dimensions are reduced and defect sizes are also reduced. Accordingly, it is necessary to change the inspection condition of the inspection apparatus for extracting defects and output a plurality of defects extracted under respective conditions all at once. Moreover, as the inspection apparatus sensitivity is increased, the output noise of the inspection apparatus is increased and there is a case that the number of defects detected in one inspection exceeds several tens of thousands. For removing the noise, there is known a method for classifying the defects being inspected by the real-time defect classification (RDC) function and removing the noise. For example, JP-A-2001-156141 discloses a technique for easily performing defect analysis by deciding the defect detection condition in the inspection apparatus and the condition when using the real-time defect classification (RDC) function for removing the noise. That is, as much as information outputted from the inspection apparatus are ordered according to the defect detection condition and the real-time defect classification (RDC) function use condition. Moreover, the technique orders the defect identification number and coordinate information outputted from the review apparatus as well as automatic defect review (ADR) information and automatic defect classification (ADC) outputted from the review apparatus.

As has been described above, the work to detect external defects and attached foreign matters (hereinafter, referred to simply as defects) is very important so as to improve the yield. On the other hand, as the semiconductor device size is reduced, the inspection apparatus should have ability/performance to detect more minute defects and an inspection apparatus capable of inspecting defects with a high sensitivity is now used. As the sensitivity is increased, the number of detected defects becomes enormous and a plenty of time is required.

Moreover, the semiconductor manufacturing step uses, i.e., manages and operates several inspection apparatuses having such a high sensitivity. Since inspection of the same step is performed by using a plurality of inspection apparatuses, even if the apparatus types are identical, the defect detection sensitivity may vary depending on the apparatuses. For this, the number of defects and the defects size differs and the apparatus management requires a great care by an operator. Currently, the data processing is performed by matching data one by one, which requires a complicated manual operation.

Concerning the aforementioned technique, the inventor suggests a technique for supporting a worker by data processing through information delivery between an external view inspection apparatus and a review apparatus and displaying on the screen, a defect map expressing defect distribution and an ADR image of defects.

### SUMMARY OF THE INVENTION

As has been described above, defects detected by an inspection apparatus includes detection of noise and in order to remove the noise, feedback should be performed to the inspection condition setting, which increases the information amount and makes it difficult to accurately decide the inspection condition. For this, an enormous time is required for setting the inspection condition.

Moreover, the aforementioned data has a problem that the number of detected foreign matters and defects is increasing and the characteristic amount is increasing, which requires a plenty of time for data processing and data ordering. In particular, an enormous amount of image data is outputted from the review apparatus as the processing speed of the apparatus is increased and it is becoming more and more difficult to process the automatically outputted images.

The aforementioned JP-A-2006-173589 by the inventor displays a defect map expressing a defect distribution state and an ADR image of defects so as to support the operator. However, as the information amount further increases in the future, it is necessary to provide a method and apparatus capable of sufficiently supporting the operator.

It is therefore an object of the present invention to provide a defect review method and apparatus having the function to rapidly search a hint to find a cause by improving the operability and user-friendliness.

An aspect of the present invention provides a defect review method using a review apparatus for reviewing defects of an object to be inspected according to information obtained by an external view inspection apparatus which inspects an external view of the object, the method comprising: a step of displaying on a screen, a defect map explicitly indicating existence of defects in an inspection region of the object; a step of displaying on the screen, a defect image list of defect image display planes prepared in correspondence to a plenty of defects in the defect map together with the defect map; a step of receiving an operation input signal for specifying an arbitrary defect in the defect map; a step of receiving an operation signal for specifying a display plane corresponding to an arbitrary defect in the defect image list; an image distinguishing display step performed upon reception of a signal specifying an arbitrary defect in the defect map, for displaying a display plane corresponding to the specified defect in the defect image list in such a way that it is distinguished from the other defect display screen; and a map defect distinguishing display step performed upon reception of a signal specifying an arbitrary defect in the defect image list, for displaying the specified defect on the defect map in such a manner that it is distinguished from the other defects. In a preferred embodiment of the present invention, for the defects specified by the defect map side, an unseen display plane corresponding to the defects specified out of the display range of the defect image list screen is shifted into the display range of the screen. Moreover, according to another preferred embodiment of the present invention, in still another embodiment of the present invention, for the defects specified by the defect image list screen side, the corresponding defects are blinked when displayed on the defect map. According to a yet another embodiment of the present invention, the display plane of the defect image list displays an image of corresponding defects obtained by the review apparatus.

According to the present invention, it is possible to effectively support a work of a review worker by improving the display of the enormous images and the defect map. According to a preferred embodiment of the present invention, it is possible to check an enormous amount of defect images and check whether a desired defect has been detected and simplify the procedure for optimizing the check condition. Moreover, it is possible to significantly reduce the time and labor required for detecting a defect of importance (DOI) and optimizing the check condition.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing the entire configuration of a defect check system as an example of application of a defect review apparatus according to the present invention.

FIG. 2 explains a flow of information up to the defect review in the defect check system of FIG. 1

FIG. 3 shows an example of defect information delivered between an inspection apparatus and a review apparatus.

FIG. 4 shows an example of screen showing feature parameters in the real-time defect classification (RDC) outputted from the defect inspection apparatus.

FIG. 5 shows an example of a screen in which data matching process has been performed by a data processing apparatus.

FIG. 6 shows a screen for selecting a type of the image to be displayed in the basic screen according to an embodiment of the present invention.

FIG. 7 shows a basic screen according to an embodiment of the present invention.

FIG. 8 shows a an enlarged list of defect images shifted from the basic screen according to an embodiment of the present invention.

FIG. 9 shows a defect image narrowing window displayed on the basic screen according to an embodiment of the present invention.

FIG. 10 shows another example of screen display for enlarged display of the defect image in the basic screen according to an embodiment of the present invention.

FIG. 11 shows further another example for displaying an enlarged display of the image according to an embodiment of the present invention.

### DESCRIPTION OF THE INVENTION

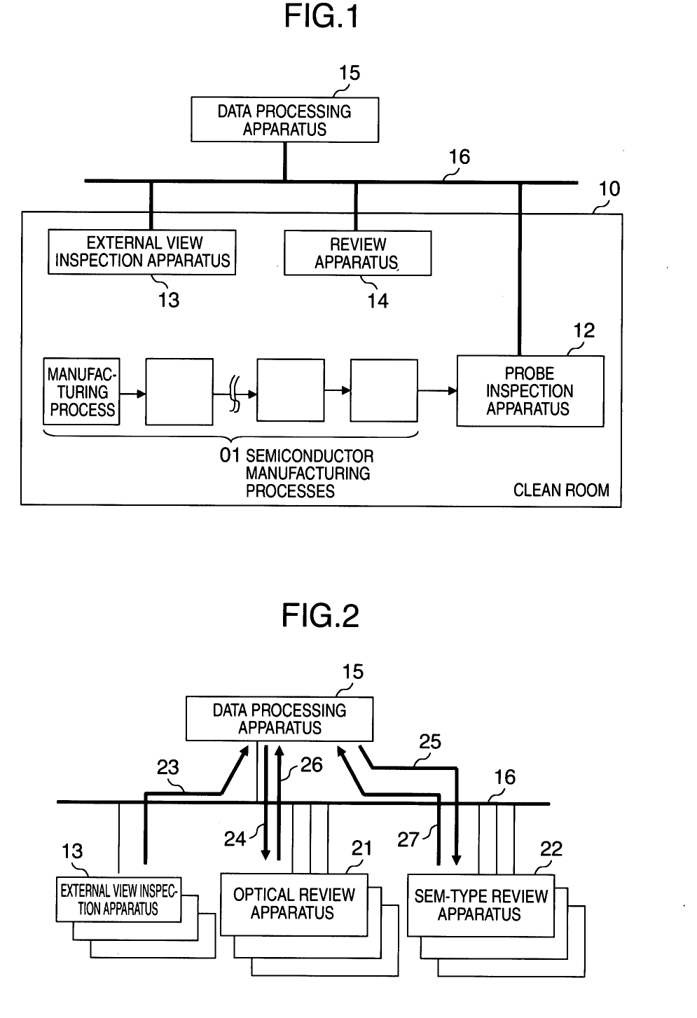

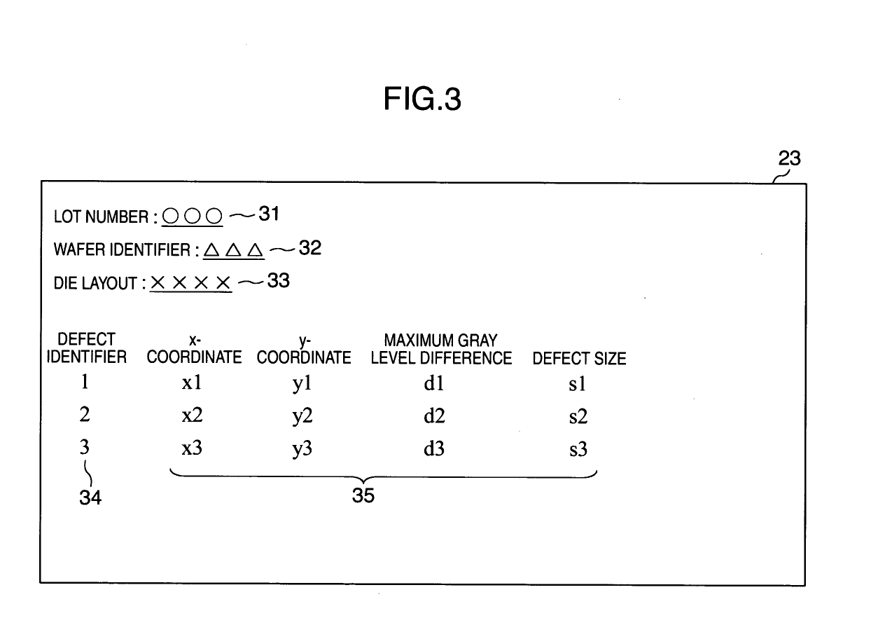

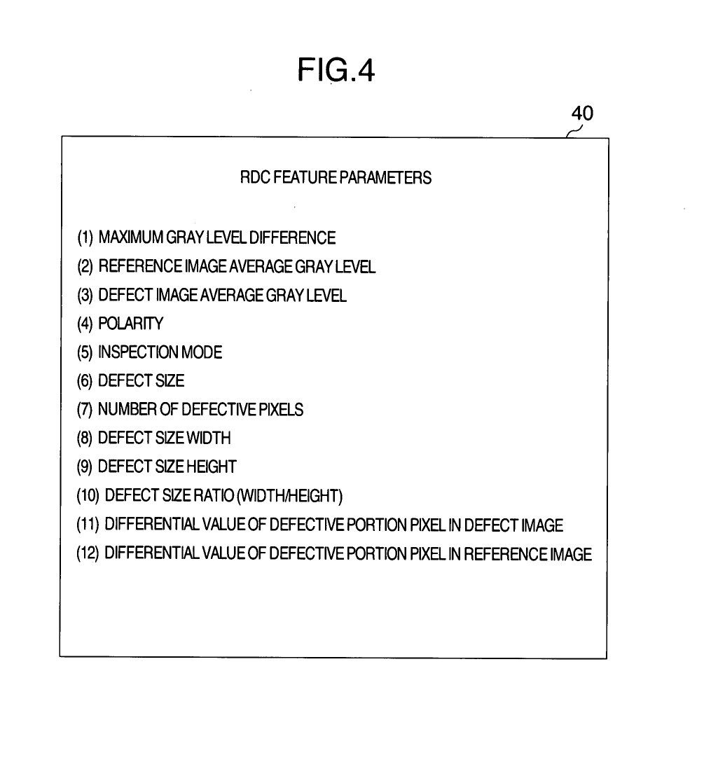

Explanation will be given on the entire configuration of the present invention with reference to FIG. 1, FIG. 2, FIG. 3, and FIG. 4. FIG. 1 shows the entire configuration of the defect check system as an application example of the defect review method and apparatus of the present invention. In a clean room 10 maintaining a clean environment, a semiconductor manufacturing step 11 and a probe inspection apparatus 12 are provided. For example, in order to inspect an external defect of a wafer product, an external inspection apparatus 13 is provided, and in order to observe, i.e., review the defect (external defect) according to the data form the external inspection apparatus 13, a review apparatus 14 is provided. The external inspection apparatus 13 and the review apparatus 14 are connected via a communication line 16 to a data processing apparatus 15 for sending and receiving inspection/image data. A wafer to become a product flows in a lot unit in the semiconductor manufacturing process 11. The external inspection apparatus 13 is carried by a worker or a feed machine after the completion of the processing of the step for which external inspection is to be performed.

FIG. 2 explains a flow of information up to the defect review in the defect checks system of FIG. 1. The defect information 23 obtained by the external inspection is managed by the data processing apparatus 15 by using a lot number, a wafer number, an inspection step, and an inspection date.

Here, description will now be directed to FIG. 3 and FIG. 4, temporarily interrupting the explanation of FIG. 2. FIG. 3 shows an example of defect information 23 sent and received between the inspection apparatus and the review apparatus. The defect information 23 includes the lot number 31, the wafer identifier 32, its die layout 33, a defect identifier 34, and its coordinate information 35. In addition to this, the defect information 23, for example, includes an automatic defect review (ADR) image, defect feature amount information (real-time defect classification (RDC) information) and the like.

FIG. 4 is an example of a screen showing feature parameters 40 in the real-time defect classification (RDC) outputted from the defect inspection apparatus. Examples of the defect feature amount information are given in FIG. 4 and there are those given below. These data are sent by the text data of a predetermined format together with the other defect information.

Firstly, the maximum gray level difference (1) is an absolute value of brightness of a defective portion when a differential image is obtained by performing image processing on a image of a portion which has been judged to be a defect and an image of its reference portion. The reference image average gray level (2) is an average value of brightness of the pixel portion judged to be a defective portion on the reference image. The defect image average gray level (3) is an average value of brightness of the pixel portion judged to be a defective portion on the defect image. The polarity (4) indicates whether the defective portion is brighter or darker than the reference image: “+” indicates a bright defect while “−” indicates a dark defect. The inspection mode (5) is an image comparison method used when the defect was detected: die comparison, cell comparison, or a mixture of them. The defect size (6), the number of defective pixels (7), the defect size width (8), the defect size height (9) show the size of the detected defect; the unit of the defect size, the width, and the height is a micron and the unit of the number of defective pixels is a pixel. The defect size ratio (10) indicates the width/height ratio of the defect size using parameters such as 1 if the width is identical to the height and 2 if the width is twice as much as the height. Lastly, the defective portion pixel differentiation value (11), (12) represents a differential value of the pixel portion judged to be defective on the defect image or the reference image and indicates the degree of the change of the shading. The value of the defect image portion is called a defective portion pixel differential value in defect image (11) and that of the reference image portion is called a defective portion pixel differential value in the reference image (12).

Here, returning to FIG. 2, explanation will be given on the flow of information and processes. After completion of an external view inspection, the wafer is fed to review apparatuses 21, 22 to review an external view defect (defect). A predetermined wafer in a lot is extracted and reviewed. When the review is performed by using an optical review apparatus 21 or a SEM-type review apparatus 22, defect information 24, 25 are acquired as information on the wafer to be reviewed, i.e., as key information including the lot number, the wafer number, and the inspection step from the data processing apparatus 15. These information 24, 25 contains not only the defect identifier and the coordinate data but also the automatic defect review (ADR) image obtained upon inspection.

Since the inspection apparatus 13 outputs enormous data as the defect information 23, only defect information 24, 25 extracted by the data processing apparatus 15 by using a plurality of filter functions are sent via a communication line 16 to the optical review apparatus 21 and the SEM-type review apparatus 22. The format of the defect information 24, 25 is generally identical to that of the defect information 23.

According to the extracted defect information 24, 25, an image of the defect detection unit is acquired by the optical review apparatus 21 and the SEM-type review apparatus 22. By using the image, the automatic defect classification (ADC) mounted on each review apparatus is used to classify the defects. The information is sent as the automatic defect review (ADR)/automatic defect class (ADC) information 26, 27 via the communication line 16 to the data processing apparatus 15.

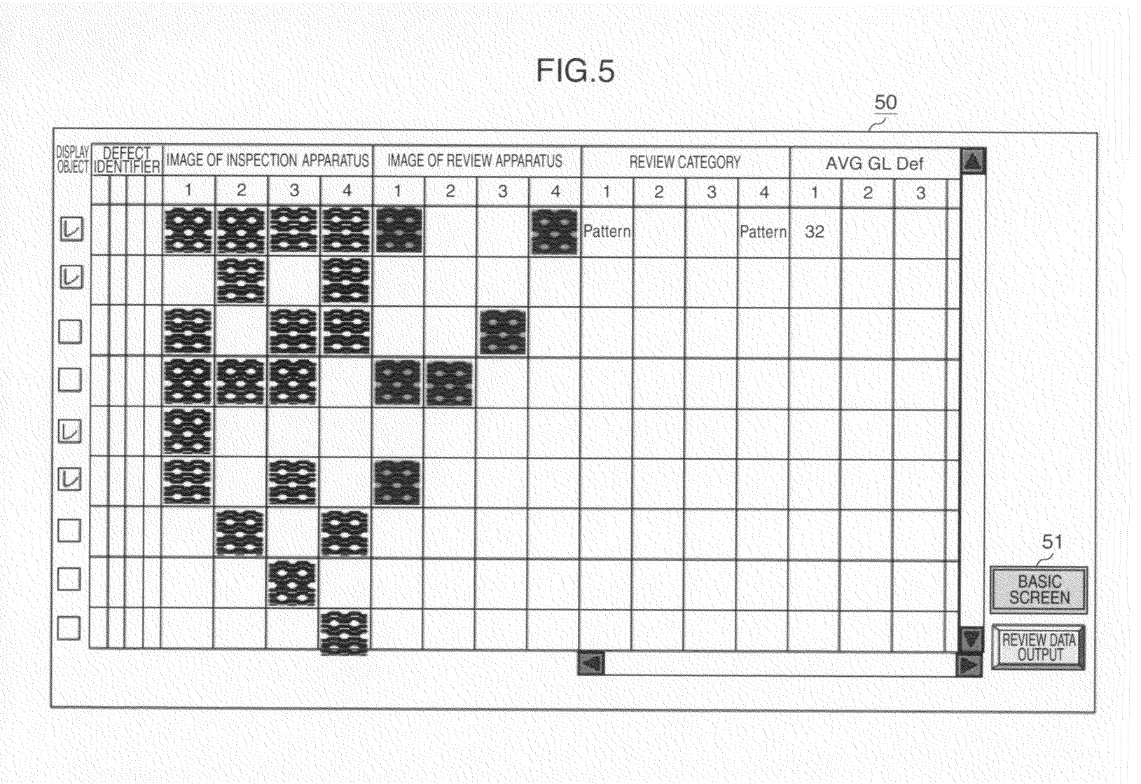

FIG. 5 is an example of a screen on which data matching is performed by the data processing apparatus. By using this example, explanation will be given on how the data processing apparatus 15 processes/displays the inspection/defect feature amount/image data outputted from the inspection apparatus and the automatic defect review (ADR)/automatic defect classification (ADC) information outputted from the review apparatus side.

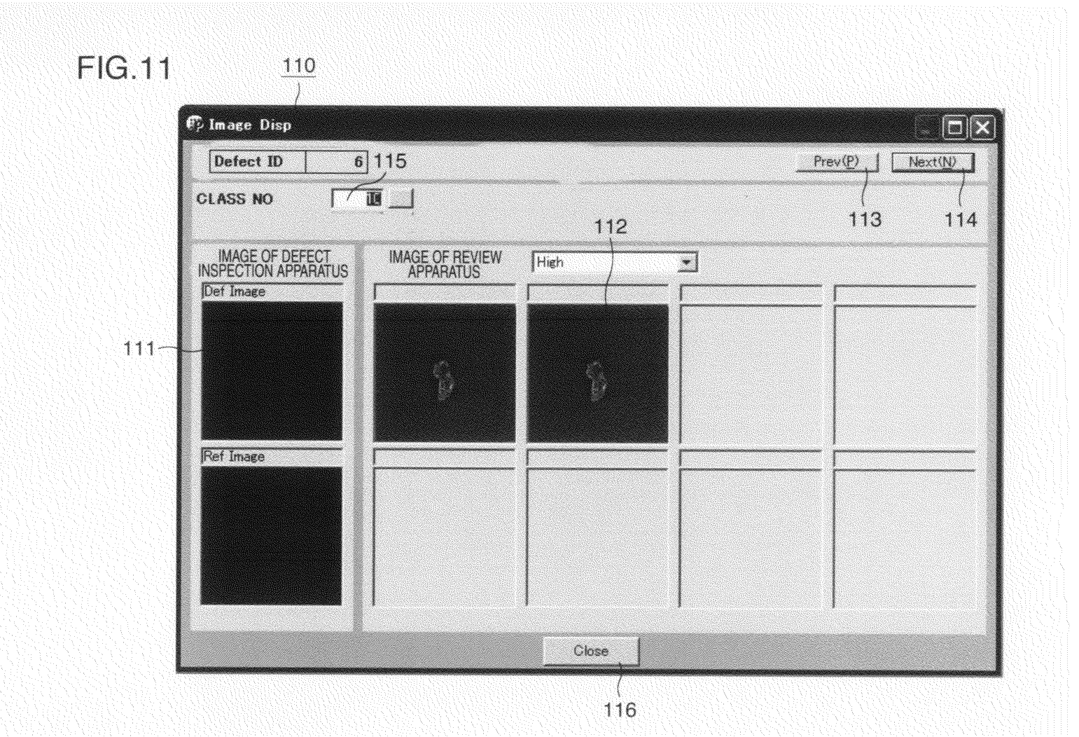

The screen 50 shown in FIG. 5 is prepared on the data processing apparatus 15 so as to display a large amount of inspection/image data 23 from the inspection apparatus together with a large amount of automatic defect review (ADR)/automatic defect classification (ADC) information from the review apparatuses 21, 22. The screen 50 is almost identical to FIG. 4 and FIG. 11 in JP-A-2006-173589. The difference is that the screen 50 includes a button 51 for shifting to the basic screen.

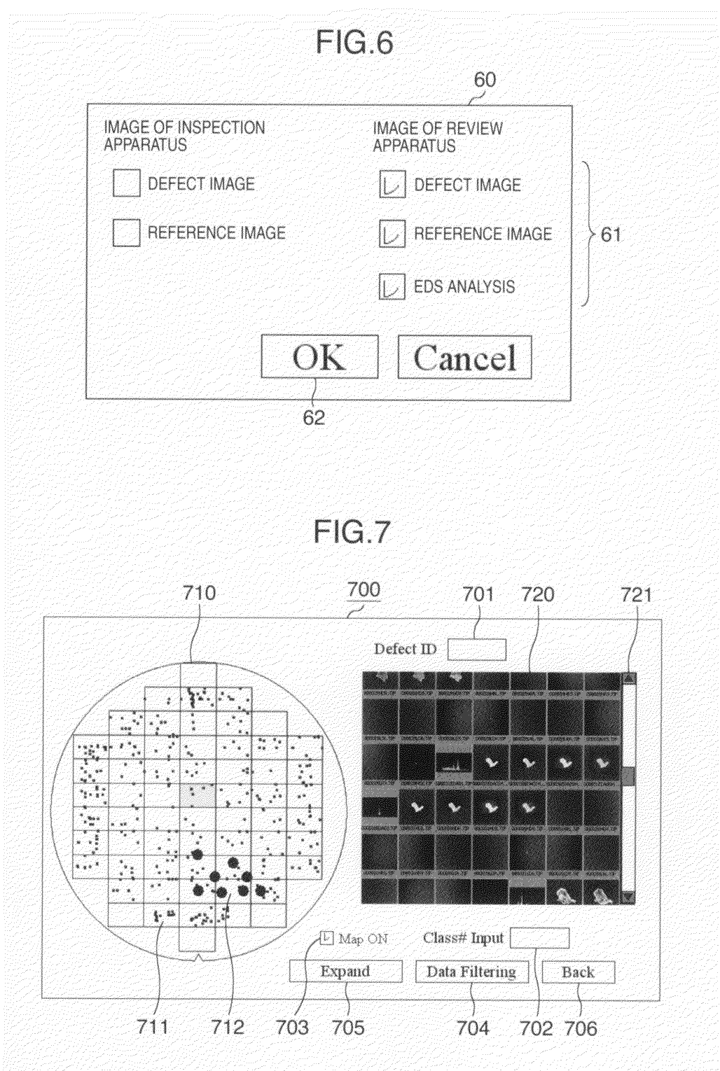

Next, referring to FIG. 6 to FIG. 11, explanation will be given on the function of the basic screen shift button 51 arranged in the screen 50 of FIG. 5 and the screen configuration according to an embodiment of the present invention. FIG. 6 is a basic screen selection window for selecting the basic screen which will be detailed later with reference to FIG. 7. By selecting any one item in the box 61 of the basic screen selection window 60 of FIG. 6 by putting a check, it is possible to select an image to be displayed on the basic screen shown in FIG. 7. After this, when the OK button 62 is pressed, the screen is shifted to the basic screen shown in FIG. 7.

FIG. 7 is an example of a screen display of the basic screen according to an embodiment of the present invention. In the basic screen 700, the defect map 710 showing defect distribution and the defect image list 720 selected in the window 50 of FIG. 5 are arranged adjacent to each other. A display plane of the image list 720 may be vertically scrolled by a scroll bar 721. The map 710 displays dots 711 indicating defects and the defects displayed in the image list 720 by large dots 712 in the map 710. When any dots 711, 712 on the map are clicked, their defect photographs are displayed in the image list 720.

On the other hand, by clicking an arbitrary defect image in the image list 720, it is possible to display the corresponding defect by the blinking dot in the map 710. In the selection of a dot and an image, if the selection is performed while pressing the shift key, it is possible to select a plurality of defects.

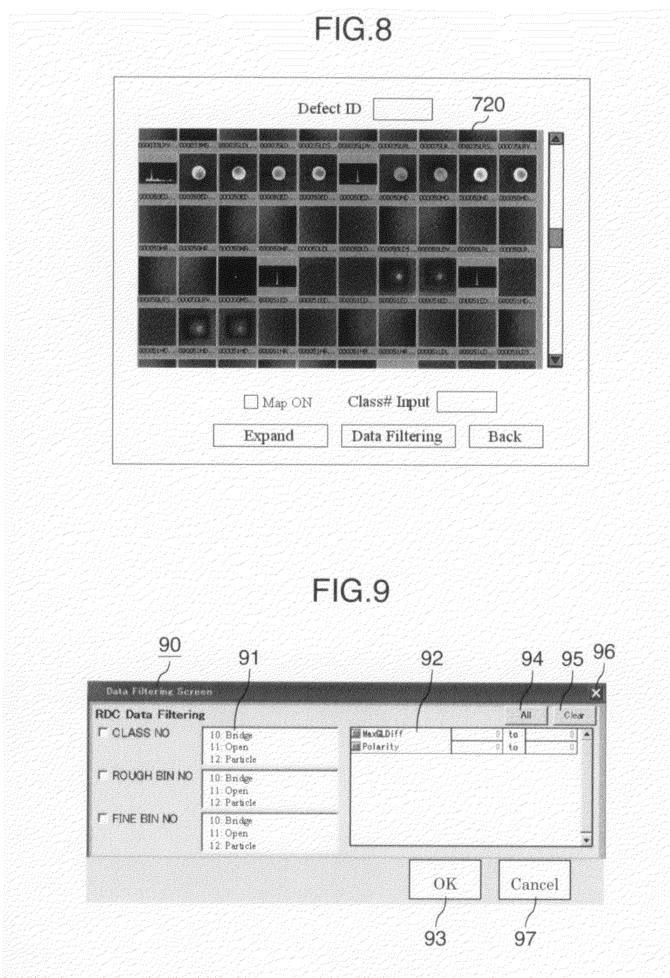

When an arbitrary defect is selected by a defect identifier input column 701, the position of the defect is indicated by the blinking dot on the map 710 and a photograph (image) of the defect is explicitly indicated in the image list 720. Moreover, when an image in the image list 720 is selected by click, an arbitrary class (numeric) is inputted in column 702 of the classification input (Class# Input), and the return key (not depicted) is pressed, it is possible to input the class number corresponding to the defect. When the check mark in the map-on window 703 is removed, the map 710 disappears from the screen and as shown in FIG. 8, the image list 720 is displayed in the entire screen. In order to filter the number of defects displayed in the image list 720, a data filtering button 704 is pressed. Then, the window 90 shown in FIG. 9 appears.

FIG. 9 is a defect image filtering window for filtering the defect images to be displayed on the basic screen according to an embodiment of the present invention. In this window 90, a selection range is inputted into a selection column 91 by the class number inputted in advance or the selection column 92 for selecting the range of the defect feature amount displayed in the window 50 of FIG. 5 and the OK button 93 is pressed. Thus, it is possible to filter the number of defects to be displayed in the image list 720 of the window 700 in FIG. 7. In FIG. 9, 94 indicates an all-selection button, 95 indicates a selection clear button, 96 indicates a window close button, and 97 indicates a cancel button.

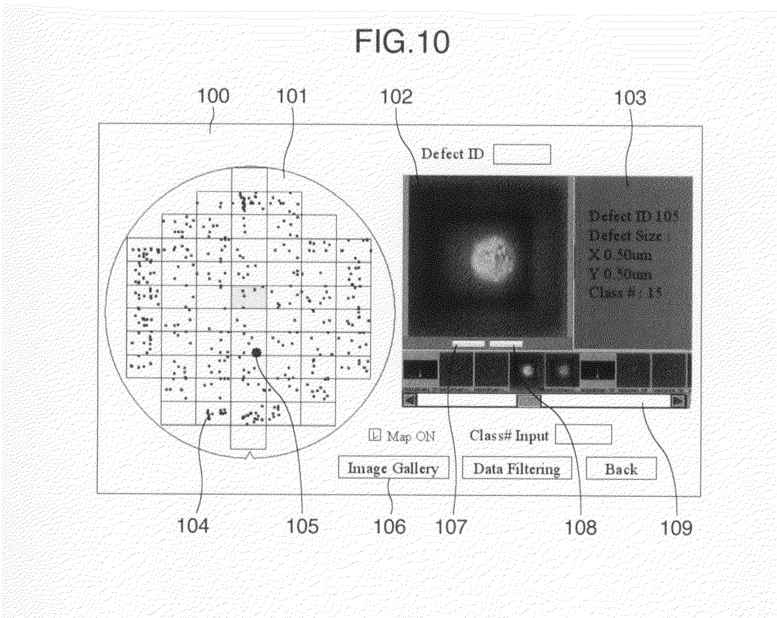

Referring back to the basic screen of FIG. 7, explanation will be continued. When a user wants to enlarge an image for observation, two types of units may be used. Firstly, by pressing the Expand button 705 in FIG. 7, a defect image enlarged display screen 100 of FIG. 10 appears.

FIG. 10 is an example of screen display for enlarged display of the defect image in the basic screen according to an embodiment of the present invention. In the left half of the screen 100, the map 101 is displayed in the same way as FIG. 7. On the other hand, in the right half, defect images of the same size as in FIG. 7 are arranged in a horizontal arrangement at the lower portion. One of the selection images is enlarged and displayed as the enlarged image 102 together with the defect information 103 corresponding to the enlarged image at the center of the right half. Moreover, in the map 101, the position of the defect is explicitly indicated by the blinking dot 105 arranged together with the other defect dots 104. It should be noted that 106 indicates an image gallery button for returning to the basic screen of FIG. 7, 107 is a button for shifting to a defect image of a preceding identifier by one, 108 is a bottom for shifting to a defect image of the next defect identifier, and 109 is a scroll button.

Secondary, when an arbitrary defect image shown in FIG. 7, 8, 10 is clicked, the window 110 shown in FIG. 11 appears, in which it is possible to check the image 111 of the inspection apparatus and the image 112 of the review apparatus. By using the buttons 113 and 114, it is also possible to check the images of the preceding and the following defect identifier. Moreover, it is possible to input an arbitrary class number from the input column 115. By pressing the close button 116, it is possible to close the window 110. Lastly, returning again to FIG. 7, by pressing the back button 706, it is possible to return to the window 50 shown in FIG. 5.

According to the present embodiment, it is possible to provide a defect review apparatus capable of acquiring data outputted from an external view inspection apparatus into the data processing apparatus 15 and easily reviewing a large amount of image data by improving the image data display and operation units.

It should be further understood by those skilled in the art that although the foregoing description has been made on embodiments of the invention, the invention is not limited thereto and various changes and modifications may be made without departing from the spirit of the invention and the scope of the appended claims.

1. A defect review method using a review apparatus for reviewing defects of an object to be inspected according to information obtained by an external view inspection apparatus which inspects an external view of the object, the method comprising:
a step of displaying on a screen, a defect map explicitly indicating existence of defects in an inspection region of the object;
a step of displaying on the screen, a defect image list of defect image display planes prepared in correspondence to a plenty of defects in the defect map together with the defect map;
a step of receiving an operation input signal for specifying an arbitrary defect in the defect map;
a step of receiving an operation signal for specifying a display plane corresponding to an arbitrary defect in the defect image list;
an image distinguishing display step performed upon reception of a signal specifying an arbitrary defect in the defect map, for displaying a display plane corresponding to the specified defect in the defect image list while distinguishing the display plane from the other defect display screen; and
a map defect distinguishing display step performed upon reception of a signal specifying an arbitrary defect in the defect image list, for displaying the specified defect on the defect map while distinguishing the specified defect from the other defects.

2. The defect review method as claimed in claim 1, wherein the image distinguishing display step includes a step for shifting a display plane corresponding to a specified defect which is out of the screen display range and not seen into the display range of the screen.

3. The defect review method as claimed in claim 1, wherein the map defect distinguishing display step includes a step for blinking-displaying a corresponding defect on the defect map.

4. The defect review method as claimed in claim 1, further comprising the steps of:
receiving an input for instructing an arbitrary defect on the display screen of the defect image list; and
displaying an enlarged image of the defect on the display plane of the defect image list upon reception of the arbitrary instruction input.

5. The defect review method as claimed in claim 1, wherein the display plane of the defect image list displays an image of a corresponding defect obtained by an optical review apparatus.

6. The defect review method as claimed in claim 1, wherein the display plane of the defect image list displays an image of a corresponding defect obtained by an SEM-type review apparatus.

7. The defect review method as claimed in claim 1, wherein the display plane of the defect image list displays a corresponding defect component analysis spectrum.

8. The defect review method as claimed in claim 1, wherein the defect image list shows defect images corresponding to the respective defects detected by the inspection apparatus and arranged horizontally and vertically so that the list can be scrolled by a scroll bar.

9. The defect review method as claimed in claim 1, further comprising the step of:
receiving a selection input to decide whether the images to be displayed on the respective display planes of the defect image list are the images concerning defects obtained by the inspection apparatus or the images concerning defects obtained by the review apparatus.

10. The defect review method as claimed in claim 1, further comprising the step of:
receiving a selection input to decide whether the images to be displayed on the respective display planes of the defect image list are defects images or reference images.

11. The defect review method as claimed in claim 1, further comprising the step of:
displaying the defects displayed in the defect image list while distinguishing the defects from the other defects on the defect map.

12. The defect review method as claimed in claim 1, further comprising the step of:
displaying the defects displayed in the defect image list with a larger scale than the other defects on the defect map.

13. The defect review method as claimed in claim 1, further comprising the steps of:
receiving an input for requesting non-display of the defect map or an enlarged display of the defect image list; and
canceling the display of the defect map and displaying the defect image list with a greater scale upon reception of the request.

14. A defect review apparatus for reviewing defects of an object to be inspected according to information obtained by an external view inspection apparatus which inspects an external view of the object, the defect review apparatus comprising:
a defect map display unit displayed on a screen for explicitly indicating presence of defects in an inspection region of the object;
a defect image list display unit for enlarging and arranging defect images having a plenty of defects in the defect map, and the defect image list display unit is displayed adjacent to the defect map on the screen;
a unit for specifying an arbitrary defect on the defect map;
a unit for specifying an arbitrary defect image in the defect image list;
an image distinguishing display unit used upon specification of an arbitrary defect in the defect map, for displaying a defect image corresponding to the specified defect in the defect image list while distinguishing the defect image from the other defect display screen; and
a map defect distinguishing display unit used upon specification of an arbitrary defect in the defect image list, for displaying the specified defect in the defect map while distinguishing the specified defect from the other defects.

15. The defect review apparatus as claimed in claim 14, wherein the image distinguishing display unit includes a unit for shifting a display plane corresponding to a specified defect which is out of the screen display range and not seen into the display range of the screen.

16. The defect review apparatus as claimed in claim 14, wherein the map defect distinguishing display unit includes a unit for blinking-displaying a corresponding defect on the defect map.

17. The defect review apparatus as claimed in claim 14, further comprising:
an enlarged instruction input reception unit for receiving an instruction to instruct enlargement of an arbitrary defect image on the display plane of the defect image list; and
an enlarged image display unit for displaying an enlarged image of the defect on the display plane of the defect image list upon reception of enlargement instruction input for the arbitrary defect.

18. The defect review apparatus as claimed in claim 14, wherein the defect image list display unit includes a unit for displaying defect images corresponding to the respective defects detected by the inspection apparatus and arranged horizontally and vertically, and a unit for scroll-displaying the defect image list by a scroll bar.

19. The defect review apparatus as claimed in claim 14, further comprising:
a selection input unit for deciding whether the images to be displayed on the respective display planes of the defect image list are the images concerning defects obtained by the inspection apparatus or the images concerning defects obtained by the review apparatus;
a selection input unit for deciding whether the images to be displayed on the respective display planes of the defect image list are defects images or reference images; and
a unit for switching to the corresponding display mode according to the selection input.

20. A defect review apparatus for reviewing defects of an object to be inspected according to information obtained by an external view inspection apparatus which inspects an external view of the object, the review apparatus comprising:
a defect map display unit displayed on a screen for explicitly indicating existence of defects in an inspection region of the object;
a defect image list display unit for displaying defect image having a plenty of defects in the defect map while the defect images are enlarged and arranged horizontally and vertically, and the defect image list display unit is displayed adjacent to the defect map on the screen;
a scroll display unit for scrolling the defect image list by a scroll bar;
a unit for specifying an arbitrary defect on the defect map;
a display plane shift unit used when an arbitrary defect on the defect map is specified, for shifting a display plane corresponding to a specified defect which is out of the screen display range and not seen into the display range of the screen;
a blinking display unit when an arbitrary defect in the defect image list is specified, for blinking-displaying a defect corresponding to the specified defect on the defect map;
an enlargement instruction input reception unit for receiving an input for instructing enlargement of an arbitrary defect on the display plane of the defect image list; and
an enlarged image display unit for displaying an enlarged image of the defect on the display plane of the defect image list upon reception of the arbitrary instruction input.
